(19) United States
(12) Patent Application Publication
(10) Pub. No.: US 2021/0048760 A1
(43) Pub. Date: Feb. 18, 2021

(54) ELECTROSTATIC INK COMPOSITION

(71) Applicant: Hewlett-Packard Development Company, L.P., Spring, TX (US)

(72) Inventors: Israel Patla, Nes Ziona (IL); Yorai Amit, Nes Ziona (IL); Daniel Skvirsky, Nes Ziona (IL); Faina Kogan, Nes Ziona (IL); Gleb Romantcov, Nes Ziona (IL); Hanit Marom Tchaicheeyan, Nes Ziona (IL); Merav Shapira, Nes Ziona (IL)

(21) Appl. No.: 17/051,394

(22) PCT Filed: Nov. 15, 2018
(86) PCT No.: PCT/US2018/061203

§ 371 Date: Oct. 28, 2020

(51) Int. Cl. G03G 9/12; G03G 9/087; G03G 9/13; C09D 11/033; C09D 11/106

(52) U.S. Cl. CPC G03G 9/122; G03G 9/08708; C09D 11/106; G03G 9/131; C09D 11/033; G03G 9/132

(57) ABSTRACT

Described herein is an electrostatic ink composition comprising a thermoplastic resin comprising a copolymer of an alkylene monomer and an ethylenically unsaturated monomer comprising an epoxide. Also descried herein is a method of printing comprising electrostatically printing an electrostatic ink composition on a surface of a substrate, the electrostatic ink composition comprising a thermoplastic resin comprising a copolymer of an alkylene monomer and an ethylenically unsaturated monomer comprising an epoxide; and reacting the epoxide with the surface of the substrate.

### BACKGROUND

Electrophotographic printing processes, sometimes termed electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, an electrostatic ink composition including charged particles in a liquid carrier can be brought into contact with the selectively charged photoconductive surface. The charged particles adhere to the image areas of the latent image while the background areas remain clean. The image is then transferred to a print substrate (e.g., a polymer substrate) directly or by being first transferred to an intermediate transfer member, which can be a soft swelling blanket, which is often heated to fuse the solid image and evaporate the liquid carrier, and then to the print substrate.

### BRIEF DESCRIPTION OF THE FIGURES

FIG. 1 shows the effect of the shear rate on the dynamic viscosity of the Example 1 and Reference Example 1 ink compositions.

FIG. 2 shows the particle size distribution of the Example 1 and Reference Example 1 ink compositions.

FIG. 3 shows the particle conductivity of the Example 1 ink composition measured at different concentrations of SCD (charge director) and after different periods of time.

### DETAILED DESCRIPTION

Before the compositions, methods and related aspects of the disclosure are disclosed and described, it is to be understood that this disclosure is not restricted to the particular process features and materials disclosed herein because such process features and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a”, “an”, and “the” include plural referents unless the context clearly dictates otherwise.

As used herein, “liquid carrier”, “carrier”, or “carrier vehicle” refer to the fluid in which the polymer resin, absorber(s), charge directors and/or other additives can be dispersed to form a liquid electrostatic ink or electrophotographic ink. Liquid carriers can include a mixture of a variety of different agents, such as surfactants, co-solvents, viscosity modifiers, and/or other possible ingredients.

As used herein, “electrostatic ink composition” generally refers to an ink composition, which may be in liquid form, generally suitable for use in an electrostatic printing process, sometimes termed an electrophotographic printing process. The electrostatic ink composition may include chargeable particles suspended in a liquid carrier, which may be as described herein.

As used herein, “co-polymer” refers to a polymer that is polymerized from at least two monomers. However, a copolymer of a particular list of monomer types (e.g., a copolymer of monomer A and monomer B) refers to a copolymer that is polymerized from monomers of those types and no other types of monomer (e.g. an AB polymer).

As used herein, “melt flow rate” generally refers to the extrusion rate of a resin through an orifice of defined dimensions at a specified temperature and load, usually reported as temperature/load, for example, 190° C/2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

As used herein, “liquid electrostatic(ally) printing” or “liquid electrophotographic(ally) printing” generally refer to the process that provides an image that is transferred from a photo imaging substrate or plate either directly or indirectly via an intermediate transfer member to a print substrate, for example, a polymer substrate. As such, the image is not substantially absorbed into the photo imaging substrate or plate on which it is applied. Additionally, “liquid electrophotographic printers” or “liquid electrostatic printers” generally refer to those printers capable of performing electrophotographic printing or electrostatic printing, as described above. A liquid electrophotographic (LEP) printing process may involve subjecting a liquid electrophotographic ink composition to an electric field, for example, an electric field having a field strength of 1000 V/cm or more, in some examples, 1000 V/mm or more.

As used herein, “LEP image” or “printed LEP image” refer to an image which has been printed, for example, on a print substrate, by liquid electrophotographically printing a LEP ink composition described herein.

As used herein, “NVS” is an abbreviation of the term “non-volatile solids”.

As used herein, the term “about” is used to provide flexibility to a numerical range endpoint by providing that a given value may be a little above or a little below the endpoint. The degree of flexibility of this term can be dictated by the particular variable.

If a standard test is mentioned herein, unless otherwise stated, the version of the test to be referred to is the most recent at the time of filing this patent application.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and subranges within the indicated range. Thus, included in this numerical range are individual values such as 2, 3.5, and 4 and sub-ranges such as from 1-3, from 2-4, and from 3-5, and so on. This same principle applies to ranges reciting a single numerical value. Furthermore, such an interpretation should apply regardless of the breadth of the range or the characteristics being described.

As used herein, unless specified otherwise, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided an electrostatic ink composition comprising:
a thermoplastic resin comprising a copolymer of an alkylene monomer and an ethylenically unsaturated monomer comprising an epoxide.

In another aspect, there is provided a method of printing comprising:
electrostatically printing an electrostatic ink composition on a surface of a substrate, the electrostatic ink composition comprising a thermoplastic resin comprising a copolymer of an alkylene monomer and an ethylenically unsaturated monomer comprising an epoxide; and
reacting the epoxide with the surface of the substrate.

In a further aspect, there is provided a substrate having electrostatically printed thereon an electrostatic ink composition comprising a thermoplastic resin comprising a copolymer of an alkylene monomer and an ethylenically unsaturated monomer comprising an epoxide such that the epoxide has reacted with the surface of the substrate.

Currently, liquid electrostatic printing onto polymer substrates, for example, polypropylene, requires the application of a primer, for example a primer containing a polyethylene imine or a poly(ethylene-co-acrylic acid), before the liquid electrostatic ink is applied in order for the ink to adhere to the polymer substrate. Moreover, even with the use of a primer, a varnish or laminated overlayer is required for printed images to be considered water, chemical and heat resistant, as well as resistant to mechanical wear. It has been found that the use of a copolymer of an alkylene monomer and an ethylenically unsaturated monomer comprising an epoxide, for example, poly(ethylene-co-glycidyl methacrylate), in the liquid electrostatic ink removes the need for both the primer and the varnish/laminated overlayer when printing on these difficult substrates. By removing the need for a primer and varnish/laminated overlayer reductions in machinery cost, maintenance requirements and printing time and cost are also achieved.

Electrostatic Ink Composition

The electrostatic ink composition may comprise a thermoplastic resin comprising a copolymer of an alkylene monomer and an ethylenically unsaturated monomer comprising an epoxide.

The electrostatic ink composition may be a liquid electrostatic ink composition. The liquid electrostatic ink may comprise a carrier liquid and a thermoplastic resin, which may be suspended in the carrier liquid. The liquid electrostatic ink composition may comprise a carrier liquid and chargeable particles suspended in the carrier liquid. The chargeable particles may comprise a thermoplastic resin. The thermoplastic resin may comprise a copolymer of an alkylene monomer and an ethylenically unsaturated monomer comprising an epoxide.

The chargeable particles may comprise a thermoplastic resin and a colorant. In some examples, the electrostatic ink composition may comprise a thermoplastic resin and a colorant.

In some examples, the electrostatic ink composition may comprise a thermoplastic resin and a charge director. In some examples, the electrostatic ink composition may comprise a thermoplastic resin, a colorant and a charge director.

In some examples, the electrostatic ink composition may comprise a thermoplastic resin and a charge adjuvant. In some examples, the electrostatic ink composition may comprise a thermoplastic resin, a colorant and a charge adjuvant. In some examples, the electrostatic ink composition may comprise a thermoplastic resin, a charge director and a charge adjuvant. In some examples, the electrostatic ink composition may comprise a thermoplastic resin, a colorant, a charge director and a charge adjuvant.

In some examples, the thermoplastic resin constitutes about 10 wt. % to about 99 wt. %, in some examples, about 15 wt. % to about 95 wt. % of the solids of the electrostatic ink composition. In some examples, the thermoplastic resin constitutes about 20 wt. % to about 95 wt. % of the solids of the electrostatic ink composition. In some examples, the thermoplastic resin constitutes about 35 wt. % to about 95 wt. %, in some examples, about 75 wt. % to about 95 wt. %, in some examples, about 35 wt. % to about 99 wt. %, in some examples, about 75 wt. % to 99 wt. % of the solids of the electrostatic ink. In some examples, the thermoplastic resin constitutes about 80 wt. % to 95 wt. % of the solids of the electrostatic ink composition, in some examples, about 85 wt. % to about 95 wt. % of the solids of the electrostatic ink composition, in some examples, about 89 wt. % to about 93 wt. % of the solids of the electrostatic ink composition.

Copolymer

In some examples, the thermoplastic resin comprises a copolymer of an alkylene monomer and an ethylenically unsaturated monomer comprising an epoxide. The copolymer of an alkylene monomer and an ethylenically unsaturated monomer comprising an epoxide may be referred to herein as “the copolymer”. In some examples, the copolymer consists of an alkylene monomer and an ethylenically unsaturated monomer comprising an epoxide.

In some examples, the copolymer of an alkylene monomer and an ethylenically unsaturated monomer comprising an epoxide constitutes at least 20 wt. % of the thermoplastic resin, for example, at least 30 wt. %, at least 40 wt. %, at least 50 wt. %, at least 60 wt. %, at least 70 wt. %, at least 75 wt. %, at least 80 wt. %, at least 85 wt. %, at least 90 wt. %, at least 95 wt. %, at least 96 wt. %, at least 97 wt. %, at least 98 wt. %, at least 99 wt. % of the thermoplastic resin. In some examples, the copolymer of an alkylene monomer and an ethylenically unsaturated monomer comprising an epoxide constitutes 100 wt. % of the thermoplastic resin.

In some examples, the copolymer may have a melt flow rate (190° C./2.16 kg) of 30 g/10 min or less, in some examples, 25 g/10 min or less, in some examples, 20 g/10 min or less, in some examples, 15 g/10 min or less, in some examples, 10 g/10 min or less, in some examples, 9 g/10 min or less, in some examples, 8 g/10 min or less, in some examples, 7 g/10 min or less, in some examples, 6 g/10 min or less, in some examples, about 5 g/10 min. In some examples, the copolymer may have a melt flow rate (190° C./2.16 kg) of 0.5 g/10 min or more, in some examples, 1 g/10 min or more, in some examples, 1.5 g/10 min or more, in some examples, 2 g/10 min or more, in some examples, 2.5 g/10 min or more, in some examples, 3 g/10 min or more, in some examples, 3.5 g/10 min or more, in some examples, 4 g/10 min or more, in some examples, 4.5 g/10 min or more, in some examples, about 5 g/10 min. In some examples, the copolymer may have a melt flow rate (190° C./2.16 kg) of 0.5 g/10 min to 30 g/10 min, in some examples, 1 g/10 min to 25 g/10 min, in some examples, 1.5 g/10 min to 20 g/10 min, in some examples, 2 g/10 min to 15 g/10 min, in some examples, 2.5 g/10 min to 10 g/10 min, in some examples, 3 g/10 min to 9 g/10 min, in some examples, 3.5 g/10 min to 8 g/10 min, in some examples, 4 g/10 min to 7 g/10 min, in some examples, 4.5 g/10 min to 6 g/10 min, in some examples, 4 g/10 min to 6 g/10 min.

In some examples, the ethylenically unsaturated monomer comprising an epoxide constitutes at least 1 wt. % of the copolymer, for example, at least 1.5 wt. %, at least 2 wt. %, at least 2.5 wt. %, at least 3 wt. %, at least 3.5 wt. %, at least 4 wt. %, at least 4.5 wt. %, at least 5 wt. %, at least 5.5 wt. %, at least 6 wt. %, at least 6.5 wt. % of the copolymer.

In some examples, the ethylenically unsaturated monomer comprising an epoxide constitutes 50 wt. % or less of the copolymer, for example, 25 wt. % or less, 20 wt. % or less, 15 wt. % or less, 14 wt. % or less, 13 wt. % or less, 12 wt. % or less, 11 wt. % or less, 10.5 wt. % or less, 10 wt. % or less, 9.5 wt. % or less, 9 wt. % or less of the copolymer.

In some examples, the ethylenically unsaturated monomer comprising an epoxide constitutes from about 1 wt. % to about 50 wt. % of the copolymer, for example, from about 1.5 wt. % to about 25 wt. %, from about 2 wt. % to about 20 wt. %, from about 2.5 wt. % to about 15 wt. %, from about 3 wt. % to about 14 wt. %, from about 3.5 wt. % to about 13 wt. %, from about 4 wt. % to about 12 wt. %, from about 4.5 wt. % to about 11 wt. %, from about 5 wt. % to about 10.5 wt. %, from about 5.5 wt. % to about 10 wt. %, from about 6 wt. % to about 9.5 wt. %, from about 6.5 wt. % to about 9 wt. % of the copolymer. The alkylene monomer constitutes the remaining weight percent of the copolymer.

In some examples, the alkylene monomer comprises any alkylene monomer. In some examples, the alkylene monomer comprises a monomer selected from the group consisting of ethylene and propylene. In some example, the alkylene monomer is ethylene.

Ethylenically Unsaturated Monomer Comprising an Epoxide

In some examples, an ethylenically unsaturated monomer comprising an epoxide is any monomer comprising a carbon-carbon double bond and an epoxide.

As used herein, the term “ethylenically unsaturated monomer” is used to indicate the presence of one carbon-carbon double bond in the monomer, which reacts during the polymerisation reaction to form the copolymer, thus forming a carbon-carbon single bond in the copolymer.

In some examples, the ethylenically unsaturated monomer comprising an epoxide may comprise one or more epoxide groups per molecule. In some examples, the ethylenically unsaturated monomer comprising an epoxide may comprise one epoxide group per molecule.

In some examples, the ethylenically unsaturated monomer comprising an epoxide is an ethylenically unsaturated ketone comprising an epoxide, an ethylenically unsaturated amide comprising an epoxide, an ethylenically unsaturated thioester comprising an epoxide, an ethylenically unsaturated ester comprising an epoxide, or a combination thereof. In some examples, the ethylenically unsaturated monomer comprising an epoxide is an ethylenically unsaturated ester comprising an epoxide. In some examples, the ethylenically unsaturated amide comprising an epoxide may be an amide of an ethylenically unsaturated carboxylic acid and an epoxide-containing amine, for example, an epoxide-containing primary amine or an epoxide-containing secondary amine. In some examples, the ethylenically unsaturated thioester comprising an epoxide may be a thioester of an ethylenically unsaturated carboxylic acid and an epoxide-containing thiol. In some examples, the ethylenically unsaturated ester comprising an epoxide may be an ester of an ethylenically unsaturated carboxylic acid and an epoxide-containing alcohol.

In some examples, the ethylenically unsaturated carboxylic acid may be any compound containing a carboxylic acid and a single carbon-carbon double bond. In some examples, the ethylenically unsaturated carboxylic acid comprises an α,β-unsaturated, α-alkyl carboxylic acid. In some examples, the α,β-unsaturated, α-alkyl carboxylic acid may be further substituted.

In some examples, the α,β-unsaturated, α-alkyl carboxylic acid comprises an α-alkyl substituted C1 to C10 α,β-unsaturated carboxylic acid, for example, an α-alkyl substituted C1 to C6 α,β-unsaturated carboxylic acid. In some examples, the α,β-unsaturated, α-alkyl carboxylic acid is selected from the group consisting of a 2-alkylpent-2-enoic acid, 2-alkylbutan-2-enoic acid and a 2-alkylprop-2-enoic acid. In some examples, the α,β-unsaturated, α-alkyl carboxylic acid is a 2-alkylprop-2-enoic acid.

In some examples, the α-alkyl group of the α,β-unsaturated, α-alkyl carboxylic acid is a substituted or unsubstituted alkyl group. In some examples, the α-alkyl substituent of the α,β-unsaturated, α-alkyl carboxylic acid (for example, the 2-alkyl substituent of 2-alkylprop-2-enoic acid) is a C1 to C10 alkyl group, for example, a C1 to C6 alkyl, such as methyl, ethyl, propyl (e.g., n-propyl or isopropyl), or butyl (e.g., n-butyl, sec-butyl, isobutyl or tert-butyl). In some examples, the α-alkyl substituent of the α,β-unsaturated, α-alkyl carboxylic acid (for example, the 2-alkyl substituent of 2-alkylprop-2-enoic acid) is selected the group consisting of methyl, ethyl and propyl. In some examples, the α-alkyl substituent of the α,β-unsaturated, α-alkyl carboxylic acid is methyl.

In some examples, the ethylenically unsaturated carboxylic acid is selected from 2-propylprop-2-enoic acid, 2-ethylprop-2-enoic acid and 2-methylprop-2-enoic acid. In some examples, the ethylenically unsaturated carboxylic acid is 2-methylprop-2-enoic acid, which is also known as methacrylic acid.

In some examples, the epoxide-containing alcohol may be any compound containing an epoxide group and an alcohol group. In some examples, the epoxide-containing alcohol may be any alkane containing an epoxide group and an alcohol.

In some examples, the epoxide-containing alcohol comprises a primary alcohol, a secondary alcohol or a tertiary alcohol. In some examples, the epoxide-containing alcohol comprises a primary alcohol.

In some examples, the epoxide-containing alcohol may comprise a mono-substituted epoxide (also referred to herein as a terminal epoxide), a disubstituted epoxide, a tri-substituted epoxide or a tetra-substituted epoxide. In some examples, the epoxide-containing alcohol may comprise a mono-substituted or a disubstituted epoxide. In some examples, the epoxide-containing alcohol may comprise a terminal epoxide. In some examples, the disubstituted epoxide may have the formula —CR(O)CH₂. A terminal epoxide is an epoxide having the formula —CH(O)CH₂.

In some examples, the epoxide-containing alcohol may comprise a primary alcohol and a terminal epoxide.

In some examples, the epoxide-containing alcohol may be any epoxide-containing alcohol. In some examples, the epoxide-containing alcohol may comprise 2 to 30 carbon atoms, for example, 3 to 25 carbon atoms, 3 to 20 carbon atoms, 3 to 15 carbon atoms, 3 to 10 carbon atoms, 3 to 5 carbon atoms, 3 to 4 carbon atoms. In some examples, the epoxide-containing alcohol may be selected from glycidol (i.e., 2,3-epoxy-1-propanol), epoxybutanol (e.g., 3,4-epoxy-1-butanol), epoxypentanol (e.g., 4,5-epoxy-1-pentanol). In some examples, the epoxide-containing alcohol may be glycidol.

In some examples, the ethylenically unsaturated ester comprising an epoxide may be selected from glycidyl methacrylate, glycidyl 2-ethylprop-2-enoate, glycidyl 2-propylprop-2-enoate, epoxybutanyl methacrylate, epoxybutanyl 2-ethylprop-2-enoate, epoxybutanyl 2-propylprop-2-enoate, epoxypentanyl methacrylate, epoxypentanyl 2-ethylprop-2-enoate, epoxypentanyl 2-propylprop-2-enoate. In some examples, the ethylenically unsaturated ester comprising an epoxide is glycidyl methacrylate.

Colorant

An electrostatic ink composition may comprise a colorant. The colorant may be a dye or a pigment. The colorant can be any colorant compatible with the liquid carrier and useful for electrophotographic printing. For example, the colorant may be present as pigment particles or may comprise a resin (in addition to the resins described herein) and a pigment. The resins and pigments can be any of those standardly used. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW SGT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. In some examples, the pigment may be a white pigment. Where the pigment is a white pigment particle, the pigment particle may be selected from the group consisting of TiO₂, calcium carbonate, zinc oxide, and mixtures thereof. In some examples, the white pigment particle may comprise an alumina-TiO₂ pigment.

In some examples, the colorant or pigment particles may have a median particle size (particle diameter) or d₅₀ of 20 μm or less, for example, 15 μm or less, for example, 10 μm or less, for example, 5 μm or less, for example, 4 μm or less, for example, 3 μm or less, for example, 2 μm or less, for example, 1 μm or less, for example, 0.9 μm or less, for example, 0.8 μm or less, for example, 0.7 μm or less, for example, 0.6 μm or less, for example, 0.5 μm or less. Unless otherwise stated, the particle size of the colorant or pigment particle and the resin coated pigment particle is determined by using laser diffraction on a Malvern Mastersizer 2000 according to the standard procedure as described in the operating manual.

The colorant or pigment particle may be present in an electrostatic ink composition in an amount of from 10 wt. % to 80 wt. % of the total amount of resin and pigment, in some examples, 15 wt. % to 80 wt. %, in some examples, 15 wt. % to 60 wt. %, in some examples, 15 wt. % to 50 wt. %, in some examples, 15 wt. % to 40 wt. %, in some examples, 15 wt. % to 30 wt. % of the total amount of resin and colorant. In some examples, the colorant or pigment particle may be present in an electrostatic ink composition in an amount of at least 50 wt. % of the total amount of resin and colorant or pigment, for example, at least 55 wt. % of the total amount of resin and colorant or pigment.

Liquid Carrier

In some examples, for example, when printing, the electrostatic ink composition comprises a liquid carrier. Generally, the liquid carrier can act as a dispersing medium for the other components in the electrostatic ink composition. For example, the liquid carrier can comprise or be a hydrocarbon, silicone oil, vegetable oil, or the like. The liquid carrier can include, but is not limited to, an insulating, non-polar, non-aqueous liquid that can be used as a medium for toner particles. The liquid carrier can include compounds that have a resistivity in excess of about 10⁹ ohm·cm. The liquid carrier may have a dielectric constant below about 5, in some examples, below about 3. The liquid carrier can include, but is not limited to, hydrocarbons. The hydrocarbon can include, but is not limited to, an aliphatic hydrocarbon, an isomerized aliphatic hydrocarbon, a branched chain aliphatic hydrocarbon, an aromatic hydrocarbon, and combinations thereof. Examples of the liquid carrier include, but are not limited to, aliphatic hydrocarbons, isoparaffinic compounds, paraffinic compounds, dearomatized hydrocarbon compounds, and the like. In particular, the liquid carrier can include, but is not limited to, Isopar-G™, Isopar-H™, Isopar-L™, Isopar-M™, Isopar-K™, lsoparV™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before electrostatic printing, the liquid carrier can constitute about 20% to 99.5% by weight of the electrostatic ink composition, in some examples, 50% to 99.5% by weight of the electrostatic ink composition. Before printing, the liquid carrier may constitute about 40 to 90% by weight of the electrostatic ink composition. Before printing, the liquid carrier may constitute about 60% to 80% by weight of the electrostatic ink composition. Before printing, the liquid carrier may constitute about 90% to 99.5% by weight of the electrostatic ink composition, in some examples, 95% to 99% by weight of the electrostatic ink composition.

The electrostatic ink, when electrostatically printed, may be substantially free from liquid carrier. In an electrostatic printing process and/or afterwards, the liquid carrier may be removed, for example, by an electrophoresis processes during printing and/or evaporation, such that substantially just solids are transferred to the substrate. Substantially free from liquid carrier may indicate that the ink printed on the substrate contains less than 5 wt. % liquid carrier, in some examples, less than 2 wt. % liquid carrier, in some examples, less than 1 wt. % liquid carrier, in some examples, less than 0.5 wt. % liquid carrier. In some examples, the ink printed on the substrate is free from liquid carrier.

Charge Director

In some examples, the electrostatic ink composition includes a charge director.

The charge director may be added in order to impart and/or maintain sufficient electrostatic charge on ink particles during electrostatic printing, which may be chargeable particles comprising a thermoplastic resin comprising a copolymer of an alkylene monomer and an ethylenically unsaturated monomer comprising an epoxide. The charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, and the like. The charge director can be selected from, but is not limited to, oil-soluble petroleum sulfonates (e.g., neutral Calcium Petronate™, neutral Barium Petronate™, and basic Barium Petronate™), polybutylene succinimides (e.g., OLOA™ 1200 and Amoco 575), and glyceride salts (e.g., sodium salts of phosphated mono- and diglycerides with unsaturated and saturated acid substituents), sulfonic acid salts including, but not limited to, barium, sodium, calcium, and aluminium salts of sulfonic acid. The sulfonic acids may include, but are not limited to, alkyl sulfonic acids, aryl sulfonic acids, and sulfonic acids of alkyl succinates. The charge director can impart a negative charge or a positive charge on the chargeable particles of an electrostatic ink composition.

In some examples, the electrostatic ink composition comprises a charge director comprising a simple salt. Simple salts are salts that do not form micelles by themselves, although they may form a core for micelles with a micelle forming salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO³⁻, NO³⁻, HPO₄²⁻, CO₂²⁻, acetate, trifluoroacetate (TFA), Cl⁻, BF₄⁻, F⁻, ClO₄⁻, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

The charge director may include at least one of (i) soya lecithin, (ii) a barium sulfonate salt, such as basic barium petronate (BBP), and (iii) an isopropyl amine sulfonate salt. Basic barium petronate is a barium sulfonate salt of a C21-26 hydrocarbon alkyl, and can be obtained, for example, from Chemtura. An example isopropyl amine sulfonate salt is dodecyl benzene sulfonic acid isopropyl amine, which is available from Croda.

In some examples, the electrostatic ink composition comprises a charge director comprising a sulfosuccinate salt of the general formula MAₙ, wherein M is a metal, n is the valence of M, and A is an ion of the general formula (I):

[R¹—O—C(O)CH₂CH(SO₃)C(O)—O—R²]⁻ (I)

wherein each of R¹ and R² is an alkyl group.

The sulfosuccinate salt of the general formula MAₙ is an example of a micelle forming salt. The charge director may be substantially free of or free of an acid of the general formula HA, where A is as described above. The charge director may include micelles of said sulfosuccinate salt enclosing at least some of the nanoparticles. The charge director may include at least some nanoparticles having a size of 200 nm or less, and/or, in some examples, 2 nm or more.

In the formula [R¹—O—C(O)CH₂CH(SO₃⁻)C(O)—O—R²], in some examples, each of R¹ and R² is an aliphatic alkyl group. In some examples, each of R¹ and R² independently is a C3 to C30 alkyl, for example, C6-25 alkyl, C10 to C20 alkyl or C11 to C15 alkyl. In some examples,R¹ and R² are both C13 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same or different. In some examples, R¹ and R² are the same. In some examples, at least one of R¹ and R² is C₁₃H₂₇. In some examples, M is Na, K, Cs, Ca, or Ba.

In some examples, the charge director constitutes about 0.001 to 20% by weight, in some examples, 0.01 to 20% by weight, in some examples, 0.01 to 10% by weight, in some examples, 0.01 to 1% by weight of the solids of the electrostatic ink composition. In some examples, the charge director constitutes about 0.001 to 0.15% by weight of the solids of the electrostatic ink composition, in some examples, 0.001 to 0.15%, in some examples, 0.001 to 0.02% by weight of the solids of the electrostatic ink composition, in some examples, 0.1 to 2% by weight of the solids of the electrostatic ink composition, in some examples, 0.2 to 1.5% by weight of the solids of the electrostatic ink composition, in some examples, 0.1 to 1% by weight of the solids of the electrostatic ink composition, in some examples, 0.2 to 0.8% by weight of the solids of the electrostatic ink composition. In some examples, the charge director is present in an amount of at least 1 mg of charge director per gram of the liquid electrostatic ink composition (which will be abbreviated to mg/g), in some examples, at least 2 mg/g, in some examples, at least 3 mg/g, in some examples, at least 4 mg/g, in some examples, at least 5 mg/g. In some examples, the charge director is present in an amount of from 1 mg to 50 mg of charge director per gram of the liquid electrostatic ink composition (which will be abbreviated to mg/g), in some examples, from 1 mg/g to 25 mg/g, in some examples, from 1 mg/g to 20 mg/g, in some examples, from 1 mg/g to 15 mg/g, in some examples, from 1 mg/g to 10 mg/g, in some examples, from 3 mg/g to 20 mg/g, in some examples, from 3 mg/g to 15 mg/g, in some examples, from 5 mg/g to 10 mg/g.

In some examples, the charge director does not react with the epoxide group in the copolymer of an alkylene monomer and an ethylenically unsaturated monomer comprising an epoxide. In some examples, a sulfosuccinate salt based charge director may provide better charging stability than a charge director containing an amine (for example, the charge director comprising a mixture of soya lecithin, a barium sulfonate salt and an isopropyl amine sulfonate salt), thus prolonging the lifespan of the charged electrostatic ink composition. In some examples, the charging stability is not affected by the presence of an amine in the charge director.

Charge Adjuvant

In some examples, the electrostatic ink composition includes a charge adjuvant.

A charge adjuvant may promote charging of the chargeable particles when a charge director is present in the electrostatic ink composition during printing. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminium di- or tristearate. The charge adjuvant may be present in an amount of about 0.1 to 5% by weight, in some examples, about 0.1 to 1% by weight, in some examples, about 0.3 to 0.8% by weight of the solids of the electrostatic ink composition, in some examples, about 1 to 3% by weight of the solids of the electrostatic ink composition, in some examples, about 1.5 to 2.5% by weight of the solids of the electrostatic ink composition.

In some examples, the electrostatic ink composition further includes, for example, as a charge adjuvant, a salt of a multivalent cation and a fatty acid anion. The salt of a multivalent cation and a fatty acid anion can act as a charge adjuvant. The multivalent cation may, in some examples, be a divalent or a trivalent cation. In some examples, the multivalent cation is selected from Group 2, transition metals, Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C8 to C26 fatty acid anion, in some examples, a C14 to C22 fatty acid anion, in some examples, a C16 to C20 fatty acid anion, in some examples, a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt. % to 5 wt. % of the solids of the electrostatic ink composition, in some examples, in an amount of 0.1 wt. % to 2 wt. % of the solids of the electrostatic ink composition, in some examples, in an amount of 0.1 wt. % to 2 wt. % of the solids of the electrostatic ink composition, in some examples, in an amount of 0.3 wt. % to 1.5 wt. % of the solids of the electrostatic ink composition, in some examples, about 0.5 wt. % to 1.2 wt. % of the solids of the electrostatic ink composition, in some examples, about 0.8 wt. % to 1 wt. % of the solids of the electrostatic ink composition, in some examples, about 1 wt. % to 3 wt. % of the solids of the electrostatic ink composition, in some examples, about 1.5 wt. % to 2.5 wt. % of the solids of the electrostatic ink composition.

Additives

The electrostatic ink composition may include an additive or a plurality of additives. The additive or plurality of additives may be added at any stage of the method of producing the electrostatic ink composition. The additive or plurality of additives may be selected from a wax, a surfactant, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the thermoplastic resin. Specifically, the wax phase separates from the resin phase upon the cooling of the resin fused mixture on a print substrate during and after the transfer of the ink film to the print substrate, for example, from an intermediate transfer member, which may be a heated blanket.

Method of Producing the Electrostatic Ink Composition

In some examples, there is provided a method of producing an electrostatic ink composition. The method may comprise processing a thermoplastic resin comprising a copolymer of an alkylene monomer and an ethylenically unsaturated monomer comprising an epoxide to form an electrostatic ink.

In some examples, the method of producing an electrostatic ink composition may comprise polymerising an alkylene monomer and an ethylenically unsaturated monomer comprising an epoxide to form a copolymer of an alkylene monomer and an ethylenically unsaturated monomer comprising an epoxide.

In some examples, the method of producing an electrostatic ink composition may comprise suspending in a carrier liquid a thermoplastic resin comprising a copolymer of an alkylene monomer and an ethylenically unsaturated monomer comprising an epoxide. In some examples, the method of producing an electrostatic ink composition may comprise suspending in a carrier liquid chargeable particles comprising a thermoplastic resin comprising a copolymer of an alkylene monomer and an ethylenically unsaturated monomer comprising an epoxide.

In some examples, the method of producing an electrostatic ink composition may comprise combining the thermoplastic resin and the carrier liquid. In some examples, the thermoplastic resin and the carrier liquid are combined and heated to an elevated temperature. In some examples, the thermoplastic resin and the carrier liquid are combined and heated to a temperature of at least 70° C., for example, at least 80° C., for example, at least 90° C., for example, at least 100° C., for example, at least 110° C., for example, at least 120° C., for example, 130° C., for example, to melt the thermoplastic resin. In some examples, the thermoplastic resin and the carrier liquid are heated until the thermoplastic resin has melted and/or dissolved in the carrier liquid. Melting and/or dissolving of the thermoplastic resin in the carrier liquid may result in the carrier fluid appearing clear and homogeneous. In some examples, the thermoplastic resin and carrier liquid are heated before, during or after mixing. In some examples, the thermoplastic resin and the carrier liquid are mixed at a mixing rate of 500 rpm or less, for example, 400 rpm or less, for example, 300 rpm or less, for example, 200 rpm or less, for example, 100 rpm or less, for example, 75 rpm or less, for example, 50 rpm. In some examples, mixing may continue until melting and/or dissolution of the first resin in the carrier liquid is complete. In some examples, the rate of cooling of the thermoplastic resin and the carrier liquid is controlled, for example, cooling occurs at a rate of, for 10° C./min or less, for example, 5° C./min or less, 4° C./min or less, 3° C./min or less, 2° C./min or less, 1° C./min or less.

In some examples, the thermoplastic resin and the carrier liquid are combined, causing the thermoplastic resin to swell with the carrier liquid. In some examples, the thermoplastic resin and the carrier liquid are combined and heated, causing the thermoplastic resin to swell with the carrier liquid. In some examples, the thermoplastic resin and the carrier liquid are combined and heated, causing swelling and solvation of the thermoplastic resin with the carrier liquid.

In some examples, the method comprises adding a colorant to the thermoplastic resin and the carrier liquid. In some examples, the method comprises adding a colorant to the thermoplastic resin and the carrier liquid to form chargeable particles comprising the thermoplastic resin and a colorant. In some examples, the method comprises grinding the colorant and the thermoplastic resin in the presence of the carrier liquid to form a paste. In some examples, the method comprises heating and mixing the colorant and the thermoplastic resin in the presence of the carrier liquid to form a paste.

In some examples, the method comprises adding a charge adjuvant to the thermoplastic resin and the carrier liquid and optionally grinding. In some examples, the method comprises adding a charge adjuvant and a colorant to the thermoplastic resin and the carrier liquid and optionally grinding.

In some examples, the method comprises grinding at a grinding speed of at least 50 rpm. In some examples, the method comprises grinding at a grinding speed of up to about 600 rpm. In some examples, the method comprises grinding for at least 1 h, in some examples, for at least 2 h. In some examples, the method comprises grinding for up to about 12 h. In some examples, the method comprises grinding at a temperature of at least about 35° C. In some examples, the method comprises grinding at a temperature of at least about 50° C. for a first time period, in some examples, for at least 1 h, in some examples, for at least 1.5 h and then reducing the temperature to a temperature of at least 30° C., in some examples, at least 35° C. and continuing grinding for at least 5 h, in some examples, at least 9 h, in some examples, at least 10 h.

Method of Printing the Electrostatic Ink Composition

The method of printing may comprise electrostatically printing an electrostatic ink composition on a surface of a substrate, the electrostatic ink composition comprising a thermoplastic resin comprising a copolymer of an alkylene monomer and an ethylenically unsaturated monomer comprising an epoxide; and reacting the epoxide with the surface of the substrate.

In some examples, the method of printing comprises electrostatically printing a liquid electrostatic ink composition.

In some examples, electrostatically printing an electrostatic ink composition comprises contacting the electrostatic ink composition with a latent electrostatic image on a surface to create a developed image and transferring the developed image to the substrate, in some examples, via an intermediate transfer member.

In some examples, the surface on which the (latent) electrostatic image is formed or developed may be on a rotating member, for example, in the form of a cylinder. The surface on which the (latent) electrostatic image is formed or developed may form part of a photoimaging plate. The method may involve passing the electrostatic ink composition between a stationary electrode and a rotating member, which may be a member having the surface having the (latent) electrostatic image thereon or a member in contact with the surface having the (latent) electrostatic image thereon. A voltage is applied between the stationary electrode and the rotating member, such that particles adhere to the surface of the rotating member. The intermediate transfer member, if present, may be a rotating flexible member, which may be heated, for example, to a temperature of from 80 to 160° C.

In some examples, reacting the epoxide with the surface of the substrate causes ring-opening of the epoxide in the copolymer, resulting in the formation of a bond between the copolymer and the substrate.

In some examples, reacting the epoxide with the surface of the substrate comprises heating the electrostatically printed substrate. In some examples, reacting the epoxide with the surface of the substrate comprises heating to an elevated temperature. In some examples, heating to an elevated temperature comprises heating to any temperature that initiates the reaction of the epoxide with the surface of the substrate.

In some examples, heating to an elevated temperature comprises heating to any temperature that initiates the reaction of the epoxide with the surface of the substrate but does not damage, for example, melt, the substrate. In some examples, heating to an elevated temperature comprises heating to any temperature that initiates the reaction of the epoxide with the surface of the substrate but does not damage the developed image on the surface of the substrate. In some examples, heating to an elevated temperature comprises heating to at least 70° C., for example, at least 80° C., at least 90° C., at least 100° C., at least 105° C., at least 110° C., at least 115° C. or at least 120° C. In some examples, heating to an elevated temperature comprises heating to 200° C. or less, for example, 190° C. or less, 180° C. or less, 170° C. or less, 160° C. or less, 150° C. or less, 140° C. or less, 135° C. or less, 130° C. or less, 125° C. or less or 120° C. or less. In some examples, heating to an elevated temperature comprises heating to 70° C. to 200° C., for example, 80° C. to 190° C., 90° C. to 180° C., 100° C. to 170° C., 105° C. to 160° C., 110° C. to 150° C., 115° C. to 140° C., 120° C. to 135° C., 70° C. to 130° C., 80° C. to 125° C. or 90° C. to 120° C.

In some examples, before the electrostatic ink composition is electrostatically printed on the substrate, an oxidizing treatment is performed on the substrate. In some examples, before the electrostatic ink composition is electrostatically printed on the substrate, a corona treatment is performed on the substrate. The corona treatment may improve the surface polarity. During the corona treatment, polar groups, such as hydroxyl, ketone and carboxyl groups, may be grafted onto the surface of the substrate. The substrate may be pre-treated in a corona chamber at room temperature and atmospheric pressure.

In some examples, the method of printing may comprise oxidising the surface of a substrate; electrostatically printing an electrostatic ink composition on the surface of the substrate, the electrostatic ink composition comprising a thermoplastic resin comprising a copolymer of an alkylene monomer and an ethylenically unsaturated monomer comprising an epoxide; and reacting the epoxide with the surface of the substrate.

In some examples, the method of printing may comprise performing a corona treatment on a surface of a substrate; electrostatically printing an electrostatic ink composition on the surface of the substrate, the electrostatic ink composition comprising a thermoplastic resin comprising a copolymer of an alkylene monomer and an ethylenically unsaturated monomer comprising an epoxide; and reacting the epoxide with the surface of the substrate.

Printed Substrate

In some examples, there is provided a substrate having electrostatically printed thereon an electrostatic ink composition comprising a thermoplastic resin comprising a copolymer of an alkylene monomer and an ethylenically unsaturated monomer comprising an epoxide such that the epoxide has reacted with the surface of the substrate.

In some examples, the epoxide has reacted with the surface of the substrate such that bonds have been formed between the copolymer and the substrate.

In some examples, the epoxide has reacted with the surface of the substrate in a ring-opening reaction.

Substrate

In some examples, the substrate is any substrate capable of having an electrostatic ink composition electrostatically printed thereon.

In some examples, the substrate is any substrate having a surface capable of reacting with an epoxide. In some examples, the substrate is any substrate having a surface that, after an oxidizing treatment, is capable of reacting with an epoxide. In some examples, the substrate is any substrate having a surface that, after corona treatment, is capable of reacting with an epoxide.

In some examples, the substrate may include a material selected from an organic or inorganic material. The substrate may include a natural polymeric material or a synthetic polymeric material.

In some examples, the natural polymeric material may be cellulose. In some examples, the substrate comprises cellulosic paper. In some examples, the cellulosic paper is coated with a polymeric material, for example, a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. In some examples, the substrate is a cellulosic substrate such as paper. The cellulosic substrate may be an uncoated cellulosic substrate or a coated cellulosic substrate.

In some examples, the substrate comprises any suitable textile or fabric substrate. In some examples, the textile or fabric substrate may be a network of natural or synthetic fibres. The fabric substrate may be woven or non-woven. The textile or fabric substrate may be formed of yarns, for example, spun threads or filaments, which may be natural or synthetic material or a combination thereof. The textile or fabric substrate may include substrates that have fibres that may be natural and/or synthetic. The substrate may comprise any textile, fabric material, fabric clothing, or other fabric product onto which it is desired to apply printed matter. The term “textile” includes, by way of example, cloth, fabric material, fabric clothing or other fabric products. The textile substrate may have warp and weft yarns. The terms “warp” and “weft” refer to weaving terms that have their ordinary meaning in the textile arts, that is, warp refers to lengthwise or longitudinal yarns on a loom whereas weft refers to crosswise or transverse yarns on a loom. The textile substrate may be woven, non-woven, knitted, tufted, crocheted, knotted, and/or have a pressed structure.

In some examples, the substrate may include a metal, which may be in sheet form. In some examples, the substrate may comprise a metallic foil or a metallized substrate. In some examples, the substrate may comprise an aluminium foil. In some examples, the substrate may comprise a metallized paper (i.e., paper having a metal layer thereon) or a metallized plastic substrate (i.e., a plastic substrate having a metal layer thereon).

The metal may be selected from or made from, for example, aluminium (Al), silver (Ag), tin (Sn), copper (Cu), or mixtures thereof.

In some examples, the substrate is a polymer substrate. In some examples, the polymer substrate may be a copolymer. In some examples, the polymer substrate may be a polymer formed from alkylene monomers. In some examples, the polymer substrate may comprise an acrylic substrate. In some examples, the polymer substrate comprises acrylic, polyethylene (PE), linear low density polyethylene (LLDPE), low density polyethylene (LDPE), medium density polyethylene (MDPE), high density polyethylene (HDPE), polypropylene (PP), cast polypropylene (cPP), biaxially oriented polypropylene (BOPP), polyamide (PA), oriented polyamide (OPA), or polyethylene terephthalate (PET).

In some examples, the substrate may comprise a plurality of layers of material, in some examples, a plurality of layers of material laminated together. In some examples, the substrate may comprise a plurality of layers of material selected from polymeric materials (e.g., polymeric materials selected form PE, LLDPE, MDPE, PP, cPP, BOPP, PA, OPA and PET), metallic materials (e.g., metallic foils such as aluminium foil, or metallized substrates such as metallized-PET or metallized BOPP), paper and combinations thereof. In some examples, the substrate comprises a plurality of layers of polymeric material (such as a combination of layers selected from PE, LLDPE, MDPE, PP, BOPP, PET and OPA) laminated together.

In some examples, the substrate comprises polypropylene and the polypropylene is corona treated before the electrostatic ink composition is electrostatically printed on the surface of the polypropylene.

In some examples, the substrate comprises polyethylene terephthalate and no corona treatment is used before the electrostatic ink composition is electrostatically printed on the surface of the polypropylene.

In some examples, the substrate has a thickness of 300 μm or less, for example, 250 μm or less, 200 μm or less, 150 μm or less, 100 μm or less, 90 μm or less, 80 μm or less, 70 μm or less, 60 μm or less, 50 μm or less, 40 μm or less, 30 μm or less, 20 μm or less, or 15 μm or less. In some examples, the substrate has a thickness of 15 μm or more, for example, 20 μm or more, 30 μm or more, 40 μm or more, 50 μm or more, 60 μm or more, 70 μm or more, 80 μm or more, 90 μm or more, or 100 μm or more. In some examples, the substrate has a thickness of 15 μm to 100 μm, for example, 20 μm to 90 μm, 30 μm to 80 μm, 40 μm to 70 μm, or 50 μm to 50 μm.

### EXAMPLES

The following illustrates examples of the methods and other aspects described herein. Thus, these Examples should not be considered as limitations of the present disclosure, but are merely in place to teach how to make examples of the present disclosure.

Materials

Thermoplastic Resin

Poly(ethylene-co-glycidyl methacrylate): a copolymer of ethylene and glycidyl methacrylate containing 6.5 to 9.0 wt. % glycidyl methacrylate with a melt flow rate of 4.0 g/10 min to 6.0 g/10 min (190° C./2.16 kg); available as pellets from Sigma-Aldrich™ under product number 430862.

Carrier Liquid

Isopar L™: an isoparaffinic oil comprising a mixture of C11-C13 isoalkanes; produced by Exxon Mobil™; CAS number 64742-48-9.

Pigment

Main cyan pigment: LIONOL BLUE FG-7351; produced by Toyo Chem.

Secondary cyan pigment: HELIOGEN GREEN D8730; produced by BASF

Additive

DS72: AEROSIL® R 7200: a hydrophobic fumed silica; available from Degussa AG.

Charge Adjuvant

VCA: an aluminium stearate; available from Sigma-Aldrich™.

Charge Director

SCD: a barium bis(sulfosuccinate) salt, namely a barium phosphate and a sulfosuccinate moiety of the general formula [R¹—O—C(O)CH₂CH(SO₃)C(O)—O—R²], wherein each of R¹ and R² independently is a C₆₋₂₅ alkyl, generally mainly C₁₃ alkyl.

### Example 1

### Preparation of the Electrostatic Ink

A paste was prepared by mixing poly(ethylene-co-glycidyl methacrylate) resin (1000 g) with Isopar L™ (2000 g) at 50 rpm in a ROSS mixer (33.3 wt. % non-volatile solids (NVS). The mixing procedure is outlined in Table 1 and results in the formation of the resin paste containing poly(ethylene-co-glycidyl methacrylate) (i.e., the copolymer of an alkylene monomer and an ethylenically unsaturated monomer comprising an epoxide).

TABLE 1

| | |
|---|---|
| Mixer temperature | Mixing time |

| | | |
|---|---|---|
| 270° F. | (132.22° C.) | 90 min |
| 220° F. | (104.44° C.) | 15 min |
| 200° F. | (93.33° C.) | 15 min |
| 180° F. | (82.22° C.) | 15 min |
| 160° F. | (71.11° C.) | 15 min |
| 140° F. | (60.00° C.) | 15 min |
| 120° F. | (48.89° C.) | 15 min |
| 100° F. | (37.78° C.) | 15 min |
| 80° F. | (26.67° C.) | 15 min |

A cyan ink was prepared from the paste by combining the components listed in Table 2 in an S1 reactor filled with metal grinding balls.

TABLE 2

| Component | Quantity (g) |
|---|---|
| Resin paste (described above; | 752 |
| 33.3 wt. % NVS) | |
| Main cyan pigment | 59 |
| Secondary cyan pigment | 6 |
| DS72 | 10 |
| VCA | 11 |
| Isopar L ™ | 1464 |

The components were mixed at 250 rpm for 1.5 h at 58° C. followed by further mixing for 10.5 hat 36° C. to obtain 2.4 kg of concentrated cyan ink (9.9 wt. % NVS).

The concentrated cyan ink (340 g of the 9.9 wt. % NVS mixture) was then diluted with Isopar L™ (1160 g) to form the cyan electrostatic ink composition (2.2 wt. % NVS; the working ink dispersion). The obtained working ink dispersion was filtered by using a 200 μm sieve. Fifteen minutes prior to printing, SCD solution was added to the working ink dispersion (2.6 mg/g of working ink dispersion; 5.4 wt. % NVS).

### Example 2

A cyan electrostatic ink composition was prepared as in Example 1 but by using the proportions provided in Table 3 below.

TABLE 3

| Component | Quantity (g) |
|---|---|
| Resin paste (described above; | 1138.9 |
| 33.3 wt. % NVS) | |
| Main cyan pigment | 59.2 |
| Secondary cyan pigment | 4.4 |
| DS72 | 9.79 |
| VCA | 10.8 |
| Isopar L ™ | 1047.6 |

The tests described below were also performed for the electrostatic ink composition prepared according to Example 2 and provided comparable results to those for the Example 1 ink composition.

### Reference Example 1

A reference ink composition was obtained by diluting cyan ElectroInk™ 4.5 (21 wt. % NVS; available from HP Indigo™) with Isopar L™ to obtain 2.0 wt. % NVS solution. The same concentration of SCD (2.6 mg/g of working dispersion) was used for charging the ink composition. ElectroInk™ 4.5 contains a thermoplastic resin comprising a 4:1 mixture of Nucrel™ 699 (a copolymer of ethylene and methacrylic acid; available from DuPont™) and A-C 5120™ (a copolymer of ethylene and acrylic acid; available from Honeywell™).

The Reference Example 1 ink composition could be prepared by following the procedure of Example 1 but replacing poly-(ethylene-co-glycidyl methacrylate) resin with a 4:1 mixture of Nucrel™ 699 and A-C 5120™.

Tests

Dynamic Viscosity

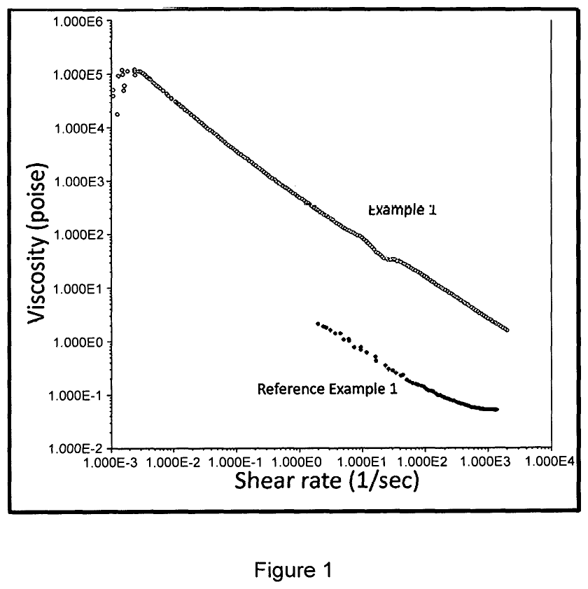

The dynamic viscosity of the ink prepared in Example 1 was compared to that of the Reference Example 1 ink. The dynamic viscosity was measured by using the rotating plate technique on an Advanced Rheometer instrument (AR 2000 rheometer available from TA instruments; spindle type: 40 mm parallel plate, rotational speed: 0.001-1100 1/sec equivalent to a max linear speed of 1.26×10⁻⁴ m/s to 138 m/s, temperature: 25° C., operation mode: flow), FIG. 1 shows the viscosity versus shear rate of each ink composition.

At all tested shear rates the Example 1 ink (containing the copolymer of an alkylene monomer and an ethylenically unsaturated monomer comprising an epoxide; 9.9% NVS) had a dynamic viscosity that was about 100 times higher than the Reference Example 1 ink (8.4% NVS).

Particle Size Distribution

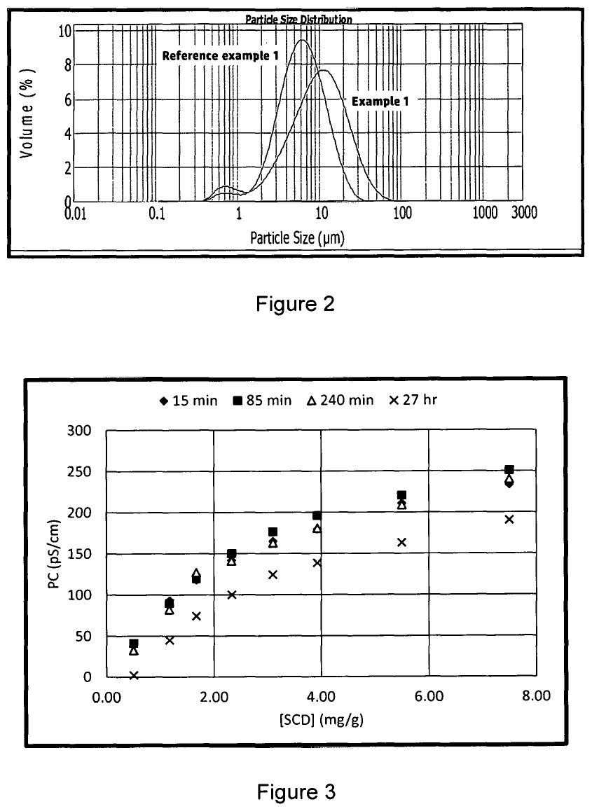

The particle size distribution (particle diameter) of the Example 1 and Reference Example 1 ink compositions was measured by using a Mastersizer 3000 instrument (available from Malvern). The particle size distributions are shown in FIG. 2.

A significantly wider particle size distribution was obtained for the Example 1 ink composition than for the Reference Example 1 ink composition. Additionally, the median particle diameter, that is, the d(0.5), for the Example 1 ink composition (9.9 μm) is higher than for the Reference Example 1 ink composition (6.2 μm).

Particle Conductivity

The charging of the Example 1 ink composition was studied using SCD as the charge director. The particle conductivity (PC) was calculated by subtracting the low field conductivity (LF) from the high field conductivity (HF), where LF was measured using a LF probe and HF was measured by a Q/M device that measures electrophoretic conductivity at high field (PC=HF−LF, measured in pS/cm). The particle conductivity was measured at different SCD concentrations and after different periods of time and the results are shown in FIG. 3.

Based on the observed change in particle conductivity, a concentration of 3 mg/g was selected for printing the Example 1 ink compositions and the ink compositions were printed 15 min after the SCD was added.

Electrostatic Printing Tests

A sheet of polypropylene (Send/Satin White untreated sheet, 0.22 mm thickness) was subjected to Corona treatment (manual corona approx. 40 Watt) to oxidise the surface. The Example 1 electrostatic ink composition (2.2 wt. % NVS) was electrostatically printed on the surface of the polypropylene substrate by using the binary ink developer (BID) of an HP Indigo 7000 sheet fed printing press. The BID voltages used to obtain 400% solid cyan coverage are provided in Table 4.

TABLE 4

| BID Component | Voltage (V) |
|---|---|
| Electrode | 1636 |
| Developer | 511 |
| Squeegee | 836 |
| Cleaner | 186 |

After printing, the substrate was placed in an oven (at 120° C.) for 5 min to bond the electrostatic ink with the polypropylene substrate (that is, to react the epoxide with the oxygen (—OH, —COOH, etc.) groups on the surface of the corona-treated polypropylene).

The Reference Example 1 ink composition (2.0 wt. % NVS) was also printed and heated in the same way by using the BID voltages in Table 4 at 400% solid coverage.

Optical Density

The optical density (OD) of the ink on the printed substrates was measured by using an optical densitometer from X-rite™. Results are provided in Table 5.

Peeling Test

Peeling tests were performed on the printed substrates produced using the Example 1 and Reference Example 1 electrostatic ink compositions with (t=5 min) and without (t=0) the printed substrates having been heated in the oven at 120° C. for 5 min.

Peeling tests were then performed by applying adhesive tape (3M Scotch tape 810) to the printed substrate by rolling a 2 kg roller over the adhesive tape 4 times. The adhesive tape was then removed rapidly at 180° over 2 seconds. Visual inspection of the printed substrates was used to estimate the percentage of the ink remaining on the printed area of the substrate. Results are provided in Table 5.

Cold Water Resistance Tests

The printed substrate was submerged in water at room temperature for 1, 4 and 24 h. After submersion, the printed substrate was wiped. Peeling tests were then performed as described above. Results are provided in Table 5.

Hot Water Resistance

The printed substrate was submerged in hot water (90° C.) for 30 min. After submersion, the printed substrate was wiped. Peeling tests were then performed as described above. Results are provided in Table 5.

Chemical Resistance

Printed substrates were submerged in various chemicals (acetone, 70 wt. % ethanol and 30 wt. % sulfuric acid) at room temperature for 2 h (acetone and ethanol) or 18 h (sulfuric acid). After submersion, the printed substrates were wiped. Peeling tests were then performed as described above. Results are provided in Table 5.

TABLE 5

| | | | | | Reference |
|---|---|---|---|---|---|
| Ink | | | | Example 1 | Example 1 |
| Optical density | | | | 2.376 | 2.275 |
| Peeling tests | | t = 0 | | 0% | 0% |
| | | t = 5 min; 120° C. | | 100% | 0% |
| Cold water resistance | | 1 | h | 100% | 0% |
| | | 4 | h | 100% | 0% |
| | | 24 | h | 100% | 20% |
| Hot water resistance | | | | 100% | 0% |
| Chemical | acetone | 2 | h | 100% | 0% |
| resistance | ethanol (70 wt. %) | 2 | h | 100% | 0% |
| | H₂SO₄ (30 wt. %) | 18 | h | 100% | 0% |

As shown in Table 5, the Example 1 ink composition passed all of the tests after heating at 120° C. for 5 min, whereas the Reference Example 1 ink failed all of the tests. Since polypropylene is considered to be the most challenging plastic substrate, it is believed that the present results may be easily extrapolated to other polymer substrates. Tests on PET confirm that these results can be extrapolated to other polymer substrates.

1. An electrostatic ink composition comprising:
a thermoplastic resin comprising a copolymer of an alkylene monomer and an ethylenically unsaturated monomer comprising an epoxide.

2. The electrostatic ink composition according to claim 1, wherein the ethylenically unsaturated monomer comprising an epoxide is an ethylenically unsaturated ester comprising an epoxide.

3. The electrostatic ink composition according to claim 1, wherein the ethylenically unsaturated monomer comprising an epoxide is an ester of an ethylenically unsaturated carboxylic acid and an epoxide-containing alcohol.

4. The electrostatic ink composition according to claim 3, wherein the ethylenically unsaturated carboxylic acid is an α,β-unsaturated, α-alkyl carboxylic acid.

5. The electrostatic ink composition according to claim 4, wherein the α,β-unsaturated, α-alkyl carboxylic acid is a 2-alkylprop-2-enoic acid.

6. The electrostatic ink composition according to claim 4, wherein the α-alkyl is a C1 to C6 alkyl.

7. The electrostatic ink composition according to claim 3, wherein the epoxide-containing alcohol comprises a terminal epoxide.

8. The electrostatic ink composition according to claim 1, wherein the copolymer of an alkylene monomer and an ethylenically unsaturated monomer comprising an epoxide constitutes at least 20 wt. % of the thermoplastic resin.

9. The electrostatic ink composition according to claim 1, wherein the ethylenically unsaturated monomer comprising an epoxide constitutes at least 1 wt. % of the copolymer.

10. The electrostatic ink composition according to claim 1, wherein the alkylene monomer is selected from the group consisting of ethylene and propylene.

11. The electrostatic ink composition according to claim 1, wherein the copolymer is poly(ethylene-co-glycidyl methacrylate).

12. The electrostatic ink composition according to claim 1 further comprising a charge director comprising a sulfosuccinate salt of the general formula MAₙ, wherein M is a metal, n is the valence of M and A is an ion of the general formula [R¹—O—C(O)CH₂CH(SO₃)C(O)—O—R²] wherein each of R¹ and R² is an alkyl group.

13. A method of printing comprising:
electrostatically printing an electrostatic ink composition on a surface of a substrate, the electrostatic ink composition comprising a thermoplastic resin comprising a copolymer of an alkylene monomer and an ethylenically unsaturated monomer comprising an epoxide; and
reacting the epoxide with the surface of the substrate.

14. The method of printing according to claim 13, wherein the substrate is a polymer substrate.

15. A substrate having electrostatically printed thereon an electrostatic ink composition comprising a thermoplastic resin comprising a copolymer of an alkylene monomer and an ethylenically unsaturated monomer comprising an epoxide such that the epoxide has reacted with the surface of the substrate.
